(19) United States
(12) Patent Application Publication
(10) Pub. No.: US 2018/0144015 A1
(43) Pub. Date: May 24, 2018

(54) REDOING TRANSACTION LOG RECORDS IN PARALLEL

(71) Applicant: Microsoft Technology Licensing, LLC, Redmond, WA (US)

(72) Inventors: Girish Mittur Venkataramanappa, Redmond, WA (US); Wei Chen, Sammamish, WA (US); Nithin Mahesh, Redmond, WA (US); Peter Byrne, Redmond, WA (US); Steven John Lindell, Bellevue, WA (US); Hanumantha Rao Kodavalla, Sammamish, WA (US)

(21) Appl. No.: 15/355,083

(22) Filed: Nov. 18, 2016

(51) Int. Cl. G06F 17/30

(52) U.S. Cl. CPC G06F 17/30362; G06F 17/3048; G06F 17/30339; G06F 17/30368; G06F 17/30292

(57) ABSTRACT

Aspects extend to methods, systems, and computer program products redoing transaction log records in parallel. Different aspects of replaying log records are allocated to different threads, for example, read threads, analysis threads, logical operation redo threads, and page operation redo threads. The different threads can be distributed across different processor cores. Activities at read threads, analysis threads, logical operation redo threads, and page operation redo threads can be performed on an ongoing basis and in parallel with activities at other threads (including user tasks). In some aspects, pre-allocated memory blocks are used in a lock free manner to store log records prior to processing by a page operation redo thread.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments. For example, distributed applications can have components at a number of different computer systems.

Replaying a transaction log file is an operation used in many Relation Database Management Systems (“RDBMS”). Transaction log file replay can be used in a number of situations. For example, transaction log file replay can be used during crash recovery to recover a database from the last checkpoint. Transaction log file replay can also be used during continuous physical replication to keep a readable hot standby secondary replica up to date.

Log replay can be split into multiple phases. In an analysis phase, a transaction log is scanned to construct a dirty page table and an active transactions table. In a redo phase, data is read from log records and applied to the corresponding pages to bring them up to date. In an undo phase, remaining active transactions are rolled back.

In continuous physical replication, an analysis and a redo phase can happen as a continuous operation and an undo phase happens during a failover. Each of these phases is typically executed serially by a single thread to keep it simple and therefore bound to a single CPU core. Traditionally, performance was bound by disk Input/Output (“IO”). As such, there was little, if any, performance gain from scaling up to multiple cores. More recently entities have adopted faster IO devices (e.g., SSD/Flash based), reducing the IO bottleneck.

### BRIEF SUMMARY

Examples extend to methods, systems, and computer program products for redoing transaction log records in parallel. A read thread copies log records from a database log stream into a circular cache. The database log stream contains log records for operations performed at a database. An analysis thread analyzes the copied log records. Analysis includes for each copied log record, updating an active transactions table depending on whether a new transaction is beginning in the log record or an existing transaction is ending in the log record. Analysis also includes for each copied log record, managing transaction locks in a lock table based on a row operation described in the log record. Analysis further includes for each copied log record, dispatching the log record for redo of logical operations.

For logical operations contained in log records, a logical operation redo thread performs the logical operations at the database. For page redo operations contained in log records, the log operation redo thread links a log sequence number (LSN) for the log record to a redo log sequence number (LSN) chain for a page ID in a dirty page table. The page ID corresponds to the page in the database to which the page operation is to be applied.

Page operation redo threads perform redo of log sequence numbers (LSNs). Page operation redo threads use a page ID to access a dirty page identified in the dirty page table from the database. Page operation redo threads apply page operations corresponding to each log sequence number (LSN) in the LSN redo chain to the dirty page to form a redone page. Page operation redo threads update the database in accordance with the redone page.

Activities at read threads, analysis threads, logical operation redo threads, and page operation redo threads can be performed on an ongoing basis and in parallel with activities at other threads (including user tasks). Read threads, analysis threads, logical operation redo threads, and page operation redo threads can be distributed across different processor cores.

In some aspects, pre-allocated memory blocks are used in a lock free manner to store log records prior to processing by a page operation redo thread.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1 illustrates an example computer architecture that facilitates redoing transaction log records in parallel.

FIG. 2 illustrates a flow chart of an example method for redoing transaction log records in parallel.

FIG. 3 illustrates an example data flow for redoing transaction log records in parallel.

FIG. 4 illustrates an example computer architecture that facilitates reducing synchronization overheads.

### DETAILED DESCRIPTION

Examples extend to methods, systems, and computer program products for redoing transaction log records in parallel.

Implementations may comprise or utilize a special purpose or general-purpose computer including computer hardware, such as, for example, one or more computer and/or hardware processors (including Central Processing Units (CPUs) and/or Graphical Processing Units (GPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: log records, active transaction tables, lock tables, dirty page tables, redo Log Sequence Number (LSN) chains, pages, transactions, locks, pointers, circular caches, circular queues, arrays, wrapping structures, counts, etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, log records, active transaction tables, lock tables, dirty page tables, redo Log Sequence Number (LSN) chains, pages, transactions, locks, pointers, circular caches, circular queues, arrays, wrapping structures, counts, etc.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Thus, aspects of the invention including services, modules, components, etc. can comprise computer hardware, software, firmware, or any combination thereof to perform at least a portion of their functions. For example, a service, module, component, etc. may include computer code configured to be executed in one or more processors and/or in hardware logic/electrical circuitry controlled by the computer code.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

Within this description and the following claims, a “transaction log” is defined as a history of actions executed by a database management system (DBMS) to provide Atomicity, Consistency, Isolation, Durability (ACID) properties over crashes, hardware failures, etc. A transaction log may also be referred to as a transaction journal, database log, binary log, or audit trail.

Within this description and the following claims, a “transaction log file” or “transaction log stream” is defined as a group of database log records physically representing a transaction log. A “transaction log file” or “transaction log stream” lists changes to a database and can be maintained in a stable storage format (e.g., stored on durable storage).

In general, if after a start, a database is found in an inconsistent state or not been shut down properly, the database management system reviews the database logs for uncommitted transactions and rolls back the changes made by these transactions. Additionally, transactions that are already committed but whose changes were not yet materialized in the database are re-applied. Rolling back uncommitted transactions and re-applying committed transactions ensure atomicity and durability of transactions.

A database log record can include a Log Sequence Number (LSN), a Previous LSN, a transition ID number, and a type. A Log Sequence Number (LSN) is defined as a unique ID for a log record. Using LSNs, logs can be recovered in constant time. LSNs can assigned in monotonically increasing order, which is useful during recovery. A Previous LSN is a link to their last log record. A Transaction ID number is a reference to the database transaction generating the log record. A type describes the type of database log record. A database log record many also include information about the actual changes that triggered the log record to be written.

Other information can also be included in a database log record depending on log record type. An update log record indicates an update (change) to a database. An update log record can include a PageID field, a length and offset field, and before and after images. A pageID is a reference to a modified page. Length and offset a length in bytes and offset of the page. Before and after images include the value of the bytes of a page before and after the page change. Some databases may have logs which include one or both images.

A compensation log record indicates the rollback of a particular change to the database. Each corresponds with exactly one other update log record (although the corresponding update log record is not typically stored in the compensation log record). A compensation log record can include an undoNextLSN field. An undoNextLSN field contains the LSN of the next log record that is to be undone for transaction that wrote the last Update Log.

A commit log record indicates a decision to commit a transaction. An abort log record indicates a decision to abort and hence roll back a transaction. A completion log record indicates that all work has been done for a particular transaction. (i.e., the translation has been fully committed or aborted)

A checkpoint log record indicates that a checkpoint has been made. Checkpoint records can be used to speed up recovery. Checkpoint log records record information that eliminates the need to read a long way into a log's past. The contents of checkpoint records can vary according to checkpoint algorithm. If all dirty pages are flushed while creating the checkpoint, a checkpoint record may contain a redoLSN and an undoLSN. A redoLSN is a reference to the first log record that corresponds to a dirty page. That is, the first update that wasn't flushed at checkpoint time. This is where redo begins on recovery. An a redoLSN is a reference to the oldest log record of the oldest in-progress transaction. This is the oldest log record needed to undo all in-progress transactions.

Aspects of the invention include redoing any of these types of log records (as well as other types of log records) in parallel.

Parallel Redo

Log replay can be split into multiple phases. In an analysis phase, a transaction log is scanned to construct a dirty page table and an active transactions table. In a redo phase, data is read from log records and applied to the corresponding pages to bring them up to date. In an undo phase, remaining active transactions are rolled back. Aspects of the invention parallelize a redo phase so that multiple cores can be used to speed up the redo operation.

Some applications like SQL server used a single thread for log replay. For each log record, the single thread analyzes the log record, including: updating dirty page table, updating active transactions table, acquiring transaction locks, performing non-page operations (i.e., logical operations), such as, checkpoint, metadata cache updates, file operations, upgrade, etc. The single thread would also redo the page operation, including: fetching page from disk, decompression, decryption, compaction, and row operations, such as, insert, delete, update of rows as described in the log record.

Using parallel redo, a single log replay thread is broken up into multiple threads. A first thread reads a log into a log pool. A second thread analyzes log records. A third thread performs logical operations and then dispatches the log records to parallel redo worker threads. In one aspect, a set of parallel redo worker threads redo page operations. Threads involved parallel redo can be distributed across different CPU cores to facilitate scale up.

More specifically, a thread reads log blocks from disk into a log pool. The thread extracts log records from the blocks, copies the log blocks into a circular cache, and dispatches the log blocks for analysis. Another thread performs analysis. During analysis, the other thread examines the contents of the log record. The other thread updates an active transactions table based on whether a new transaction is beginning or existing one is ending. The other thread acquires and/or releases transaction locks based on row operation described in the log record. The other thread them dispatches the log record for redo of logical operations.

A further thread performs redo of logical operations, such as, for example, checkpoint processing and file operations (e.g., add\drop files). If the log record describes a logical operation, the further thread performs the logical operation. If the log record describes a page operation, the further thread adds this pageId to the dirty page table if it is not already added, and links the Log Sequence Number (“LSN”) of the log record to the redo LSN chain of the page. The further thread then dispatches the log record for a page redo operation.

An additional set of parallel redo threads performs page redo operations in parallel. A parallel redo manager separates dirty pages into partitions based on their page ID (e.g., using a modulo operation). The parallel redo manager assigns each partition to a corresponding redo thread, selected from among the set of parallel redo threads. The parallel redo thread performs a redo of outstanding LSNs for pages in the partition. A modulo operation (e.g., hash) helps ensure that physically collocated pages are processed by the same redo thread. Having the same redo thread process physically collected pages increases Input/Output (IO) efficiency since multiple pages can be fetched with a single IO operation.

Each parallel redo thread can operate on its corresponding partition of dirty pages. The redo thread can read a dirty page from disk and optionally decompress and/or decrypt the dirty page. The redo thread can apply a list of outstanding location in the redo LSN change to the dirty page. The redo thread can compact the page if appropriate. The redo thread can perform insert/delete/update of rows. The redo thread can also generate versions for the rows. A redo thread can also offload certain operations, such as, for example, buffer flushes, transaction releases, cache maintenance, etc. to separate helper threads.

The different types of threads can be distributed across different CPU cores (instead of being bottlenecked by a single CPU) to increase log processing efficiency.

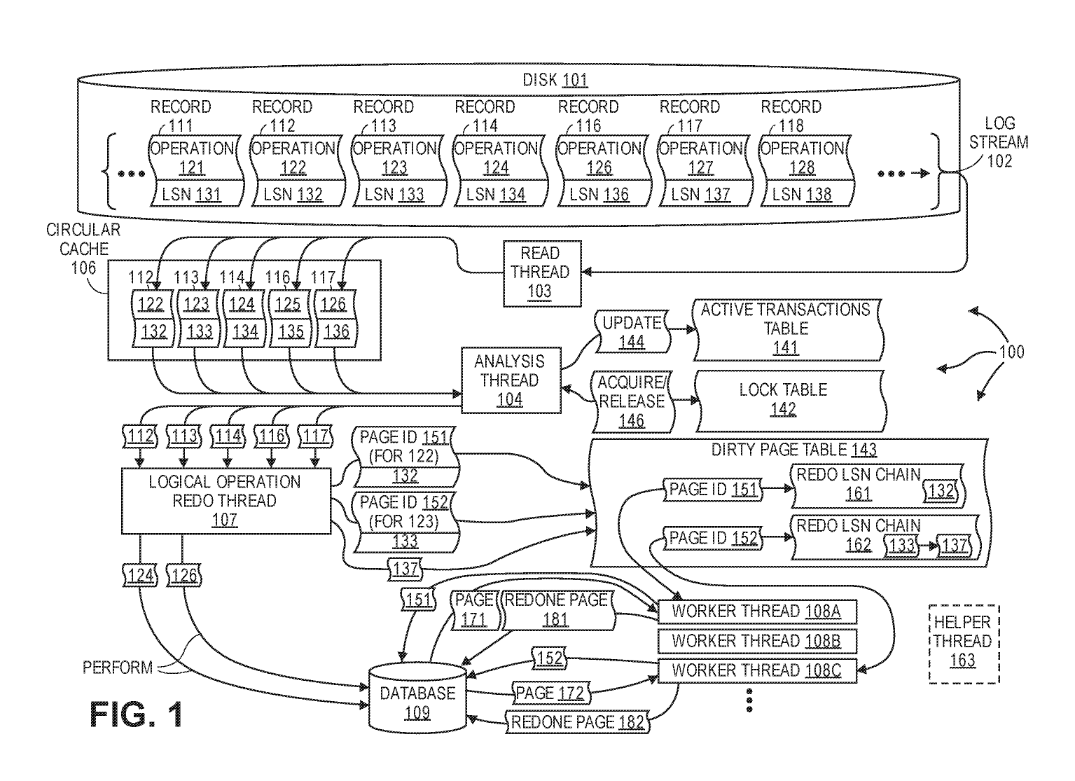

FIG. 1 illustrates an example computer architecture 100 that facilitates redoing transaction log records in parallel. Referring to FIG. 1, computer architecture 100 includes disk 101, read thread 103, circular cache 106, analysis thread 104, logical redo thread 107, worker threads 108A-108C, helper thread 163, and database 109. Disk 101, read thread 103, circular cache 106, analysis thread 104, logical redo thread 107, worker threads 108A-108C, helper thread 163, and database 109 can be connected to (or be part of) a network, such as, for example, a system bus, a Local Area Network (“LAN”), a Wide Area Network (“WAN”), and even the Internet. Accordingly, disk 101, read thread 103, circular cache 106, analysis thread 104, logical redo thread 107, worker threads 108A-108C, helper thread 163, and database 109 as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

The ellipsis below worker thread 108C represents that one or more additional worker threads may also be included in computer architecture 100.

Read thread 103, analysis thread 104, logical redo thread 107, helper thread 163, worker threads 108A-108C, and any other worker threads can operate in parallel within the context of one or more processes. The one or more processes can run on the same processor core of a (single core or multi-core) CPU, can run on different processor cores of a multi-core CPU, can run on different CPUs, or other combinations thereof. Threads within the context of the same process can share process resources and are able to execute independently. Threads within different contexts are able to execute independently.

In one aspect, each of read thread 103, analysis thread 104, logical redo thread 107, helper thread 163, worker thread 108A, worker thread 108B, worker thread 108C (and any other worker threads) are spread across CPU cores. As such, redoing transaction log records is not bottlenecked by a single CPU core and can scale up as appropriate.

A database management system (DBMS) can manage database 109 as well as one or more other databases. In one aspect, the DBMS is a relational database management system (RDBMS), such as, for example, Oracle®, MySQL®, SQL Server®, etc. As such, database 109 can be a relations database containing one or more tables. Log stream 102 is stored at disk 101. Log stream 102 can include log records 111-118 etc. stored for operations performed at database 109.

Operations performed at database 109 can include logical operations and page operations. Logical operations can include checkpoint processing operations, file operations (e.g., add/drop files), metadata cache updates, upgrades, etc. Page operations can include fetching pages from disk, decompression, decryption, compaction, inserting rows, deleting rows, updating rows, etc. Some DBMS use transactions to modify a B-tree structure, such as, for example, a page split (i.e., system transactions). A page split involves modifications to multiple pages in a single atomic (e.g., system translation).

Each log record in log stream 102 includes an indication of an operation performed at database 109 and a Log Sequence Number (LSN). For example, record 111 contains operation 121 and LSN 131, record 112 contains operation 122 and LSN 132, record 113 contains operation 123 and LSN 133, record 114 contains operation 124 and LSN 134, record 116 contains operation 126 and LSN 136, record 117 contains operation 127 and LSN 137, record 118 contains operation 128 and LSN 138, etc. Log records can also include page IDs identify a page in database 108 where an operation was applied.

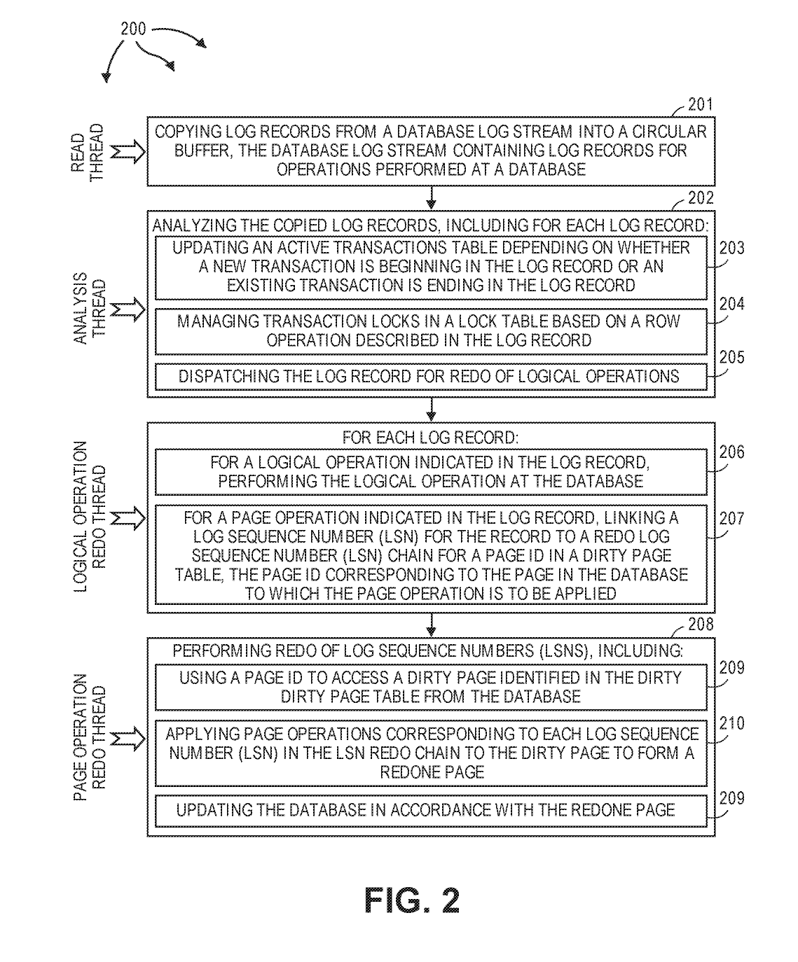

FIG. 2 illustrates a flow chart of an example method 200 for redoing transaction log records in parallel. Method 200 will be described with respect to the components and data of computer architecture 100.

Method 200 includes copying log records from a database log stream into a circular cache, the database log stream containing log records for operations performed at a database (201). For example, read thread 103 can copy log records 112, 113, 114, 116, and 117 from log stream 102 into circular cache 106. As described, log stream 102 contains log records for operations performed at database 109.

Method 200 includes analyzing the copied log records (202). For example, analysis thread 103 can analyze log records 112, 113, 114, 116, and 117. Analyzing the copied log records includes for each log record, updating an active transactions table depending on whether a new transaction is beginning in the log record or an existing transaction is ending in the log record (203). For example, analysis thread 104 can send update 144 to active transactions table 141 to indicate a new transaction is starting when a log record indicates the beginning of a transaction. On the other hand, analysis thread 104 can send update 144 to active transactions table 141 to indicate an existing transaction is ending when a log record indicates a transaction is aborted or committed.

Analyzing the copied log records includes for each log record, includes managing transaction locks in a lock table based on a row operation described in the log record (204). For example, analysis thread 104 can acquire/release 146 locks in lock table 142 based any of operations 122, 123, 124, 126, and 127 being row operations. Analyzing the copied log records includes for each log record, includes dispatching the log record for redo of logical operations (205). For example, analysis thread 104 can dispatch each of records 112, 113, 114, 116, and 117 to logical operation redo thread 107.

Method 200 includes for each log record, for a logical operation indicated in the log record, performing the logical operation at the database (206). Method 200 includes for each log record, for a page operation indicated in the log record, linking a log sequence number (LSN) for the record to a redo log sequence number (LSN) chain for a page ID in a dirty page table, the page ID corresponding to the page in the database to which the page operation is to be applied (207). As such, logical operation redo thread 107 can determine if each of operations 122, 123, 124, 126, and 127 are logical operations or page operations. In one aspect, logical operation redo thread 107 determines that operations 124 and 126 are logical operations and operations 122, 123, and 127 are page operations.

In response, logical operation redo thread 107 can perform operations 124 and 126 at database 109.

Also in response, logical operation redo thread 107 can determine that operation 122 is to be performed on a page identified by page ID 151. As such, logical operation redo thread 107 updates dirty page table 143 with page ID 151 and includes LSN 132 in LSN redo chain 161 for page ID 151. Similarly, logical operation redo thread 107 determines that operation 123 is to be performed on a page identified by page ID 152. As such, logical operation redo thread 107 updates dirty page table 143 with page ID 152 and includes LSN 133 in LSN redo chain 163 for page ID 152. Logical operation redo thread 107 also determines that operation 127 is to be performed on the page identified by page ID 152. Since page ID 152 is already included in dirty page table 143, logical operation redo thread 107 appends LSN 137 to redo LSN chain 162.

Method 200 includes performing redo of log sequence numbers (LSNs) (208). For example, worker threads 108A-108C (and any other worker threads) can redo LSNs in dirty page table 143. Performing redo of log sequence numbers (LSNs), includes using a page ID to access a dirty page identified in the dirty page table from the database (209). For example, worker thread 108A can use page ID 151 to access page 171 from database 109. When appropriate, worker thread 108A can decompress and/or decrypt page 171. In parallel, worker thread 108C can used page ID 152 to access page 172 from database 109. When appropriate, worker thread 108C can decompress and/or decrypt page 172.

Performing redo of log sequence numbers (LSNs) includes applying page operations corresponding to each log sequence number (LSN) in the LSN redo chain to the dirty page to form a redone page (210). For example, worker thread 108A can apply operation 122 (from redo LSN chain 161) to page 171 to form redone page 181. When appropriate, worker thread 108A can compact redone page 172. In parallel, worker thread 108C can apply operation 123 and then operation 127 (from redo LSN chain 162) to page 172 to form redone page 182. When appropriate, worker thread 108C can compact redone page 182.

Performing redo of log sequence numbers (LSNs) includes updating the database in accordance with the redone page (211). For example, worker thread 108A can update database 109 in accordance with redone page 181. In parallel, worker thread 108C can update database 109 in accordance with redone page 182. Updating database 109 can include inserting rows into database 109, deleting rows from database 109, or update rows in database 109. Worker thread 108A can generate row versions for any rows updated based on redone page 181. In parallel, worker thread 108C can generate row versions for any rows updated based on redone page 182.

Worker threads 108A-108C (and any other worker threads) can offload some operations, such as, for example, buffer flushes, transaction releases, and cache maintenance, to helper thread 162.

Activities at read thread 103, analysis thread 104, logical operation redo thread 107, worker threads 108A-108C (and any other worker threads), and helper thread 163 can be performed on an ongoing basis and in parallel with activities at other threads (including user tasks). For example, read thread 103 can read some records from log stream 102 in parallel with worker threads 108A-108C (and any other worker threads) processing page operations in dirty page table 143. Similarly, analysis thread 104 can analyze log entries in circular cache 106 in parallel with logical operation redo thread 107 performing logical operations at database 109 and updating dirty page table 143.

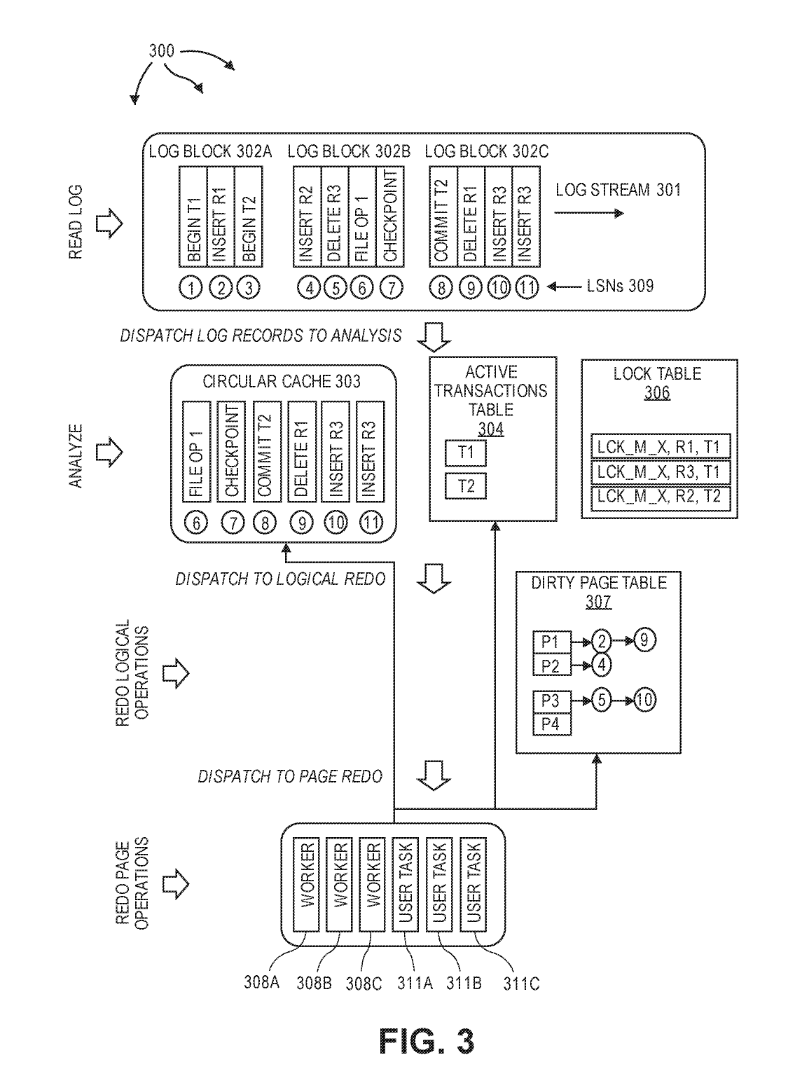

FIG. 3 illustrates an example data flow 300 for redoing transaction log records in parallel. Log stream 301 includes log blocks 302A, 302B, 302C, etc. Log records in log blocks 302A, 302B, and 302C are assigned LSNs 309. A read thread can copy log records with LSNs 6, 7, 8, 9, 10, and 11 into circular cache 303. When copied into circular cache 303, active transactions table 304 indicates that transactions T1 and T2 are active (from log records with LSNs 1 and 3 respectively). Lock tables 306 indicates that T1 has acquired locks for R1 and R3 and T2 has acquired a lock for R2.

When the record with LSN 8 is analyzed T2 can be removed from active transactions table 304. Similarly, when the record with LSN 11 is analyzed T1 can be removed from active transactions table 304. Locks in lock table 306 can also be released as rows and/or transactions complete. A logical operation redo thread can perform operations for LSNs 6 and 7 on a database. The logical operation redo thread can also update dirty page table 307 to indicate that LSNs 2 and 9 are to be performed on P1, that LSN 4 is to be performed on P2, and that LSNs 5 and 10 are to be performed on P3.

Each of worker threads 308A, 308B, and 308C can apply page operations on a corresponding page. For example, worker 308A can apply LSN 2 and then LSN 9 on P1, worker 308B can apply LSN 4 on P2, and worker 308C can apply LSN 5 and then LSN on P3. User tasks 311A, 311B, and 311C can be performed in parallel with activities of worker threads 308A, 308B, and 308C implementing parallel redo.

Readable Secondaries

While a parallel log replay is in progress on a secondary database replica, the secondary database replica is also open for read queries. Actions can be taken to help ensure that read queries can work and serve transactionally consistent data. Before a user query reads the contents of a dirty page, the user query catches up the page by redoing its list of outstanding LSNs, or waits until one of the parallel redo workers has redone this list. Since the outstanding LSN reference list is constructed in transaction order, the reader can scan the data in a transactionally consistent manner. As such, as soon as a page and its outstanding redo LSNs have been added to the dirty page table, the page is considered to have been redone as of the point in time of the last LSN. Actual redo of the page can be done lazily just before reading the page.

Many page redo operations can be performed in parallel. For some redo operations, an ordering is used. Ordering can facilitate structural consistency of a b-tree during log replay on readable secondaries. Structural consistency helps ensure correctness of b-tree scans initiated by read queries.

A database (e.g., SQL) Server can use transactions to modify b-tree structure, such as, a page split (e.g., system transactions). A page split includes modifications to multiple pages in a single atomic system transaction. For such transactions, the redo operations on the different pages involved can be ordered. To achieve ordering, the thread that dispatches to page redo introduces a dependency constraint across LSN Chains. The dependency blocks application of a LSN chain by a parallel worker if an LSN has been made dependent on another LSN belonging to a different chain and not yet applied. This ensures that updates to the pages are done in the same order as was done on the primary database replica.

B-tree scan code can include logic to reposition and retry a scan if a page which is in the middle of a system transaction is encountered. When applying outstanding LSNs of a dirty page, the logic can return as soon as it encounters an LSN of a system transaction and reads the page, which tells it that the page is in system transaction. The existing logic can then reposition and retry the scan.

When appropriate, a thread that does logical operations introduces a drain constraint where outstanding redo LSN chains of all pages are applied before further processing of the log stream is permitted. This can occur, for example, when a CheckPoint operation is encountered, to ensure correctness when the system crashes during parallel redo. After a crash, redo can begin from a checkpoint and if we can't guarantee that pages prior to checkpoint have been redone and flushed then we lose correctness.

For example, referring back to FIG. 1, logical operation redo thread 107 can prevent redo thread 103 from reading additional log entries from log stream 102, until redo LSN chains 161 and 162 are applied.

Row Versioning

During redo, an active transactions table, such as, for example, 141 or 304, is maintained. As a log stream (e.g., 102 or 301) is processed, new transaction objects get added to the active transactions table and committed transactions get removed from the active transactions table. Read queries on the secondaries run with a snapshot isolation transaction level. Row versions can be maintained where each version is associated with a transaction Id that create the row version.

A read query can read row versions of the same transaction id it began with or older, but not rows updated with a newer transaction id. One aspect of integration with parallel redo is that release of transaction objects can be delayed even after they are committed and removed from the active transactions table. The lifetime of transaction objects is controlled by a refcount based on the number of LSNs the transaction objects generated. Transaction objects remain alive and are associated with row versions generated by parallel redo workers (that are lazily applying the redo LSN chains to the pages). A transaction object is released when a last LSN apply decrements its refcount to zero.

Reducing Synchronization Overheads

During log replay, an analysis thread (e.g., 104) can attempt to minimize transaction lock and release cost by skipping lock acquisition of completed transactions. The mechanism includes looking ahead during analysis and if a transaction in the look ahead is committed or aborted, then the lock acquisition for that transaction is skipped. Additionally, to reduce synchronization overhead from multiple threads, the log records from a log pool can be copied to a lock free circular log cache (e.g., 106 or 303).

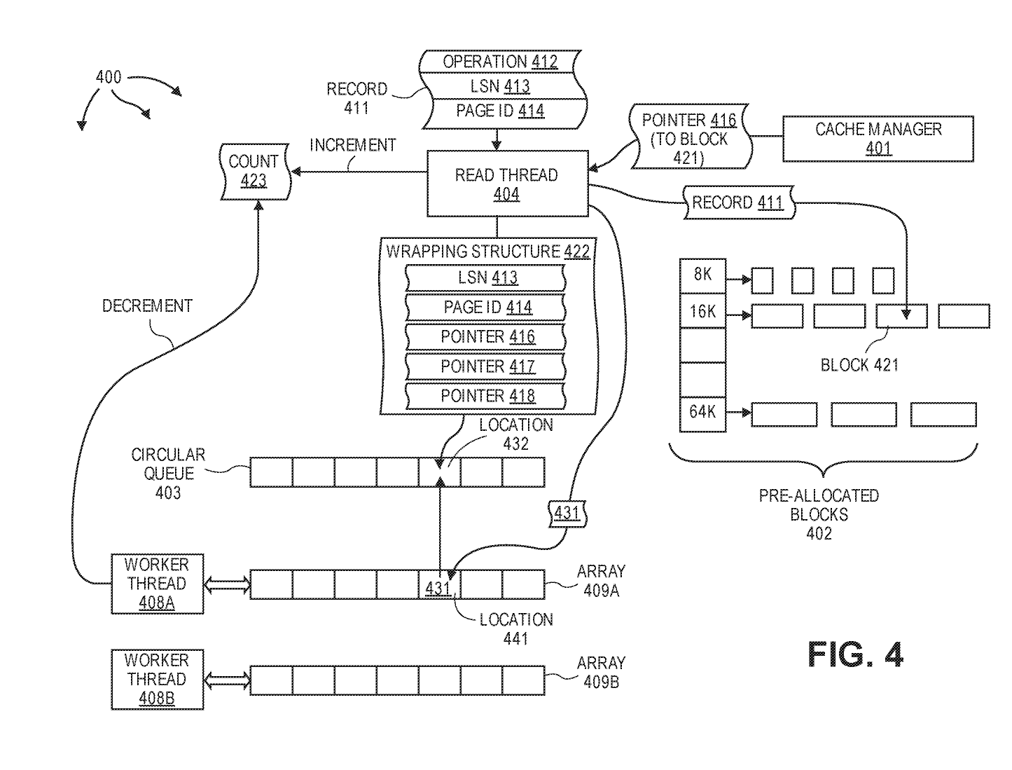

FIG. 4 illustrates an example computer architecture that facilitates reducing synchronization overheads. Referring to FIG. 4, computer architecture 400 includes cache manager 401, read thread 404, worker thread 408A, and worker thread 408B. Cache manager 401, read thread 404, worker thread 408A, and worker thread 408B can be connected to (or be part of) a network, such as, for example, a system bus, a Local Area Network (“LAN”), a Wide Area Network (“WAN”), and even the Internet. Accordingly, cache manager 401, read thread 404, worker thread 408A, and worker thread 408B as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Cache manager 401 maintains pre-allocated memory blocks 402 (e.g., of system memory) of various different sizes, such as, for example, 128 bytes, 256 bytes, 512 bytes, 1 k bytes, 2 k bytes, 4 k bytes, 8 k bytes, . . . , 24K bytes, . . . 64 k bytes, etc. Read thread 404 (having functionality similar to read thread 103) can read log record 411 from a log file or log stream (e.g., similar to log stream 102). As depicted, log record 411 includes operation 412, LSN 413, and page ID 414. Log record 411 can also include any other described fields.

Read thread 404 can communicate with cache manager 401 to obtain a memory block closest in size to log record 411. For example, log record 411 can be greater than 8 k bytes in size but smaller than 16 k bytes in size. As such, cache manager can allocate block 421 (a 16 k byte block) for log record 411. Allocating an appropriately sized block of memory reduces memory wastage.

Cache manager 401 can return pointer 416 (to block 421) back to read thread 404. Read thread 404 can use pointer 416 to store log record 411 in block 421. Read thread 404 also formulates wrapping structure 422. Wrapping structure 422 includes LSN 413, page ID 414, pointer 416, pointer 417 (to a dirty page table, for example, similar to 143 or 307), and pointer 418 (to an active transactions table, for example, similar to 141 or 307). Wrapping structure 422 can include other data, such as, for example, a DependentLSN.

Read thread 404 then enqueues wrapping structure into location 432 of circular queue 403. Read thread 404 also increments counter 432 (e.g., CountOfProduced) to indicate that new redo work has arrived. Based on a pageID partitioning function, read thread 404 can also determine which worker thread is to handle log record 411.

Each work thread maintains a circular array of indexes. Each entry in the circular array is an index into circular queue 403. For example, worker threads 408A and 408B maintain arrays 409A and 409B respectively. Each entry in array 409A and in array 409B is an index into circular queue 403. An index into an array can include a value representing an index into circular queue 403 and indicates a dispatched log record the worked thread is to handle. For example, location 441 in array 409A contains value 431. Value 431 can be an index into location 432 of circular queue 403.

Read thread 404 can store value 431 in location 441 to indicate to worker thread 408A that it is to handle log record 411. Worker thread 408A can use the contents of wrapping structure 422 to access log record 411 from block 421. Worker thread 408A can redo operation 412 in a database and also update an active transaction table and/or dirty page table as appropriate. When worker 408A has completed processor log record 411, worker 408A can change the value in location 441 so that read thread 404 knows that log record 411 has been processed. Worker thread 408A can also decrement count 423 (e.g., CountOfProduced).

Worker threads 408A and 408B can, from time to time or at specified intervals, check for additional log records to redo.

In some aspects, worker threads 408A and 408B are not fast enough so that circular queue 403 does not have available slots to store more log records. When this happens, read thread 404 can wait on a control flow event. When free slots (e.g., CountOfProdced-CountOfConsumed) reach a specified threshold, read thread 404 is contacted by a worker thread to continue enqueueing log records. Use of threshold can avoid frequent signaling which consumes computer system resources.

Circular arrays and their counters and indexes can be modified and read without the use of locks. As such, there is essentially no overhead of lock synchronization between read thread and worker threads.

After a log record is redone, the memory block (e.g., 421) is freed up but not deallocated. The memory block can then be used for other log records without the overhead of memory allocation. If there is no activity, the free blocks are eventually deallocated after a time threshold. An appropriate pattern for memory is allocate, use many times, deallocate.

Accordingly, aspects of the invention can be used for lazy redo. When a log is replayed, a list of outstanding redo log records is maintained for each dirty page. A database remains available for read operations. Log record redos are performed lazily by parallel redo threads or when a user attempts to query a page.

Operation of log read ahead, analysis, and logical redo can be offloaded to multiple threads. Log read ahead, analysis, and logical redo can be pipelined behind one another but still allocated to different CPU cores. Multiple threads can also be used in parallel for page redo operations and can be scaled as appropriate to multiple CPU cores. Pages can be partitioned such that each parallel thread is assigned a set of pages that are likely to be collocated. Assign pages that are likely to be collocated makes efficient use of read ahead IOs, where many pages can be read with a single IO.

The resource costs of lock acquisition and release are reduced by skipping lock acquisition of committed transactions. An analysis thread can use look ahead during analysis. If a transaction in the look ahead is committed, then the lock acquisition for that transaction is skipped. Use of lock free pre-allocated memory structures also reduces resource costs.

When appropriate, a thread can introduce a dependency constraint across LSN Chains. A dependency constraint blocks application of a LSN chain by a parallel worker when an LSN has been made dependent on another LSN belonging to a different chain and not yet applied. This dependency helps ensure query scan correctness when a multi-page operation like a b-tree structure modification (split) is encountered.

When appropriate, a thread can introduce a drain constraint. A drain constraint helps insure that all outstanding redo LSN chains get applied before further processing of the log stream. A drain constraint is useful, for example, when a CheckPoint operation is encountered in the log stream, to ensure correctness if the system crashes during parallel redo.

In one aspect, the release of transaction objects is delayed to allow for row versioning during parallel redo. During Redo, an active transactions table is maintained. As a log stream is processed, new transaction objects get added to the active transactions table and committed transactions get removed. Read queries on the secondaries run with a snapshot isolation transaction level. As such, row versions are maintained where each version is associated with a transaction id that generated it. The release of transaction objects are delayed even after they are committed and removed from the active transactions table. Their lifetime is controlled by a refcount based on the number of LSNs they generated. This way the transactions get associated with row versions being generated by the parallel redo threads that are lazily applying the redo LSN chains to the pages. The transaction objects are released when the last update decrements the refcount to zero.

In some aspects, a computer system comprises one or more hardware processors, system memory, a read thread, an analysis thread, a logical operation redo thread, and a set of page operation redo threads. The read thread, the analysis thread, the logical operation redo thread, and the set of page operation redo threads operate in parallel. The one or more hardware processors are configured to execute the instructions stored in the system memory to redo transaction log records in parallel.

The one or more hardware processors execute instructions stored in the system memory to cause the read thread to copy log records from a database log stream into a circular cache. The database log stream contains log records for operations performed at a database.

The one or more hardware processors execute instructions stored in the system memory to cause the analysis thread to analyze the copied log records. The one or more hardware processors execute instructions stored in the system memory to, for each log record, update an active transactions table depending on whether a new transaction is beginning in the log record or an existing transaction is ending in the log record. The one or more hardware processors execute instructions stored in the system memory to, for each log record, to manage transaction locks in a lock table based on a row operation described in the log record. The one or more hardware processors execute instructions stored in the system memory to, for each log record, dispatch the log record for redo of logical operations.

The one or more hardware processors execute instructions stored in the system memory to cause the logical operation redo thread to, for a logical operation indicated in the log record, perform the logical operation at the database. The one or more hardware processors execute instructions stored in the system memory to cause the logical operation redo thread to, for a page operation indicated in the log record, link a log sequence number (LSN) for the record to a redo log sequence number (LSN) chain for a page ID in a dirty page table. The page ID corresponds to the page in the database to which the page operation is to be applied.

The one or more hardware processors execute instructions stored in the system memory to cause each page operation redo thread in the set of page operation redo threads to performing redo of log sequence numbers (LSNs). The one or more hardware processors execute instructions stored in the system memory to cause a page operation redo thread to use a page ID to access a dirty page identified in the dirty page table from the database. The one or more hardware processors execute instructions stored in the system memory to cause a page operation redo thread to apply page operations corresponding to each log sequence number (LSN) in the LSN redo chain to the dirty page to form a redone page. The one or more hardware processors execute instructions stored in the system memory to cause a page operation redo thread to update the database in accordance with the redone page.

Computer implemented methods for redoing transaction log records in parallel are also contemplated. Computer program products for redoing transaction log records in parallel are also contemplated.

In other aspects, a computer system comprises one or more hardware processors, system memory, a read thread, and a plurality of worker threads. The read thread and a plurality of worker threads operate in parallel. The one or more hardware processors are configured to execute the instructions stored in the system memory to redo a page operations in a database.

The one or more hardware processors execute instructions stored in the system memory to cause the read thread to access a log record from a database log stream. The database log stream contains log records for operations performed at the database. The one or more hardware processors execute instructions stored in the system memory to cause the read thread to obtain a pointer to a pre-allocated memory block of appropriate size to store the log record. The one or more hardware processors execute instructions stored in the system memory to cause the read thread to use the pointer to store the log record in the pre-allocated memory block.

The one or more hardware processors execute instructions stored in the system memory to cause the read thread to store the pointer in a location in a circular queue. The one or more hardware processors execute instructions stored in the system memory to cause the read thread to insert an index value in an array corresponding to worker thread. The value points to the location in the circular queue. The worker thread is selected from among the plurality of worker threads.

The one or more hardware processors execute instructions stored in the system memory to cause the worker thread to use the index value to access the pointer from the location in the circular buffer. The one or more hardware processors execute instructions stored in the system memory to cause the worker thread to use the pointer to access the log record from the pre-allocated memory block. The one or more hardware processors execute instructions stored in the system memory to cause the worker thread to redo the log entry within the database.

Computer implemented methods for redoing a page operation are also contemplated. Computer program products for redoing a page operation are also contemplated.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A computer system, the computer system comprising:
one or more hardware processors;
system memory coupled to the one or more hardware processors, the system memory storing instructions that are executable by the one or more hardware processors;
a read thread, an analysis thread, a logical operation redo thread, and a set of page operation redo threads, the read thread, the analysis thread, the logical operation redo thread, and the set of page operation redo threads operating in parallel;
the one or more hardware processors executing the instructions stored in the system memory to redo transaction log records in parallel, including the following:
the read thread copying log records from a database log stream into a circular cache, the database log stream containing log records for operations performed at a database;
the analysis thread analyzing the copied log records, including for each log record:
updating an active transactions table depending on whether a new transaction is beginning in the log record or an existing transaction is ending in the log record;
managing transaction locks in a lock table based on a row operation described in the log record; and
dispatching the log record for redo of logical operations;
for each log record, the logical operation redo thread:
for a logical operation indicated in the log record, performing the logical operation at the database; and
for a page operation indicated in the log record, linking a log sequence number (LSN) for the record to a redo log sequence number (LSN) chain for a page ID in a dirty page table, the page ID corresponding to the page in the database to which the page operation is to be applied;
for each page operation redo thread in the set of page operation redo threads, performing redo of log sequence numbers (LSNs), including:
using a page ID to access a dirty page identified in the dirty page table from the database;
applying page operations corresponding to each log sequence number (LSN) in the redo log sequence number (LSN) chain to the dirty page to form a redone page; and
updating the database in accordance with the redone page.

2. The computer system of claim 1, wherein the one or more hardware processors executing the instructions stored in the system memory to update the database in accordance with the redone page comprises the one or more hardware processors executing the instructions stored in the system memory to modify one or more rows by performing one of more of: inserting a row, deleting a row, or updating a row.

3. The computer system of claim 1, wherein the one or more hardware processors executing the instructions stored in the system memory to update the database in accordance with the redone page comprises the one or more hardware processors executing the instructions stored in the system memory to generate versions for the one or more rows.

4. The computer system of claim 1, wherein the one or more hardware processors executing the instructions stored in the system memory to, for a logical operation indicated in the log record, perform the logical operation at the database comprises the one or more hardware processors executing the instructions stored in the system memory to perform the logical operation selected from among: a checkpoint operation, a metadata cache update, or a file operation.

5. The computer system of claim 1, wherein the one or more hardware processors executing the instructions stored in the system memory to perform redo of log sequence numbers (LSNs) comprises the one or more hardware processors executing the instructions stored in the system memory to perform on more page operations, the one or more page operations selected from among: fetching a page from disk, decompressing a page, decrypting a page, compacting page, inserting a row, deleting a row, or updating a row.

6. The computer system of claim 1, wherein the one or more hardware processors executing the instructions stored in the system memory to perform redo of log sequence numbers (LSNs) comprises the one or more hardware processors executing the instructions stored in the system memory to perform a page operation that spans a plurality of pages; and further comprising
the one or more hardware processors executing the instructions stored in the system memory to place dependency constraint across log sequence number (LSN) Chains, the dependency constraint preventing a worker thread from processing one redo log sequence number (LSN) chain for one of the plurality of pages until another worker thread has processed another redo log sequence number (LSN) chain for another of the plurality of pages such that the plurality of pages are updated in a specified order.

7. The computer system of claim 1, further comprising the one or more hardware processors executing the instructions stored in the system memory to offload one or more operations to a helper thread, the one or more operations selected from among flushing a buffer, releasing a transaction, and maintaining a cache.

8. The computer system of claim 1, further comprising the one or more hardware processors executing the instructions stored in the system memory to perform one or more user tasks in parallel with performing redo of log sequence numbers (LSNs).

9. The computer system of claim 1, further comprising the one or more hardware processors executing the instructions stored in the system memory to cause the logical operation redo thread to apply a drain constraint, the drain constraint instructing the read thread to not read additional log records until outstanding log sequence number (LSN) redo chains in the dirty page table are processed.

10. A computer system, the computer system comprising:
one or more hardware processors;
system memory coupled to the one or more hardware processors, the system memory storing instructions that are executable by the one or more hardware processors;
a read thread and a plurality of worker threads, the read thread and the plurality of worker threads operating in parallel;
the one or more hardware processors executing the instructions stored in the system memory to redo a page operation in a database, including the following:
the read thread accessing a log record from a database log stream, the database log stream containing log records for operations performed at the database;
the read thread obtaining a pointer to a pre-allocated memory block of appropriate size to store the log record;
the read thread using the pointer to store the log record in the pre-allocated memory block;
the read thread storing the pointer in a location in a circular queue;
the read thread inserting an index value in an array corresponding to worker thread, the value pointing to the location in the circular queue, the worker thread selected from among the plurality of worker threads;
the worker thread using the index value to access the pointer from the location in the circular buffer;
the worker thread using the pointer to access the log record from the pre-allocated memory block; and
the worker thread redoing the log entry within the database.

11. The computer system of claim 10, further comprising the one or more hardware processors executing the instructions stored in the system memory to cause the read thread to increment a count to indicate that new work is available for the plurality of worker threads.

12. The computer system of claim 11, further comprising, subsequent to the worker thread redoing the log entry within the database, the one or more hardware processors executing the instructions stored in the system memory to cause the worker thread to decrement the count.

13. The computer system of claim 10, wherein the one or more hardware processors executing the instructions stored in the system memory to obtain a pointer comprise one or more hardware processors executing the instructions stored in the system memory to:
indicate the size of the log record to a cache manager; and
receive a pointer to pre-allocated memory block from the cache manager, the pre-allocated memory block selected based on the indicated size.

14. The computer system of claim 10, further comprising the one or more hardware processors executing the instructions stored in the system memory to cause the read thread to wrap the pointer and data contained in the log record in a wrapping structure; and
wherein the one or more hardware processors executing the instructions stored in the system memory to store the pointer in a location in a circular queue comprises the one or more hardware processors executing the instructions stored in the system memory to store the wrapping structure in the circular queue.

15. The computer system of claim 14, wherein the one or more hardware processors executing the instructions stored in the system memory to wrap the pointer and data contained in the log record in a wrapping structure comprise the one or more hardware processors executing the instructions stored in the system memory to wrap the pointer, a Log Sequence Number (LSN), a page ID, another pointer to a dirty page table, and a pointer to an active transactions table in the wrapping structure.

16. A computer implemented method for redoing transaction log records in parallel, the method comprising:
linking a log sequence number (LSN) for a record to a redo log sequence number (LSN) chain for a page ID in a dirty page table, the page ID corresponding to a dirty page in the database to which a page operation is to be applied;
linking another log sequence number (LSN) for another record to another redo log sequence number (LSN) chain for another page ID in the dirty page table, the other page ID corresponding to another dirty page in the database to which another page operation is to be applied;
a first worker thread:
using the page ID to access the dirty page from the database;
applying page operations corresponding to each log sequence number (LSN) in the redo log sequence number (LSN) chain to the dirty page; and
updating the database based on applying the page operations corresponding to each log sequence number (LSN) in the redo log sequence number (LSN) chain; and
in parallel with activities at the first worker thread, a second worker thread:
using the other page ID to access the other dirty page from the database;
applying other page operations corresponding to each log sequence number (LSN) in the other redo log sequence number (LSN) chain to the other dirty page; and

17. The computer implemented method of claim 16, wherein copying a plurality of log records from a database log stream into a circular cache comprises copying a plurality of log records from a database log stream into a circular cache in accordance with a drain constraint, wherein the drain constraint limits reading additional log records into the circular cache until redo log sequence number (LSN) chains in a dirty page table are applied to the database

18. The computer implemented method of claim 16, further comprising copying a plurality of log records from a database log stream into a circular cache, the database log stream containing log records for operations performed at a database, the plurality of log records including the log record with the log sequence number (LSN) and the other log record with the other log sequence number (LSN).

19. The computer implemented method of claim 17, further comprises updating an active transactions table depending on whether a new transaction is beginning or an existing transaction is ending within any of the plurality of log records.

20. The computer implemented method of claim 16, further comprising performing one or more logical operations at the database in parallel with activities at the first worker thread and the second worker thread.
